(19) United States
(12) Patent Application Publication
(10) Pub. No.: US 2015/0254626 A1
(43) Pub. Date: Sep. 10, 2015

(54) TERMINAL-BASED SETTLEMENT METHOD, APPARATUS AND SYSTEM

(71) Applicant: TENCENT TECHNOLOGY (SHENZHEN) COMPANY LIMITED, Shenzhen (CN)

(72) Inventor: MAOCAI LI, Shenzhen (CN)

(73) Assignee: TENCENT TECHNOLOGY (SHENZHEN) COMPANY LIMITED

(21) Appl. No.: 14/718,503

(22) Filed: May 21, 2015

Related U.S. Application Data
(63) Continuation of application No. PCT/CN2014/084140, filed on Aug. 12, 2014.

(30) Foreign Application Priority Data
Oct. 31, 2013 (CN) 2013-10530548.2

(51) Int. Cl. G06Q 20/20; G06K 7/14

(52) U.S. Cl. CPC G06Q 20/208; G06K 7/1417

(57) ABSTRACT

A terminal-based settlement method is provided. The method includes a settlement apparatus scanning tag information of an item to be purchased and obtaining item information of the item to be purchased, where the item information includes a unique identifier and price information of the item. The method also includes the settlement apparatus generating a graphic barcode based on the unique identifier and the price information of the item. Further, the method includes the settlement apparatus receiving a settlement request for the item sent from a user terminal after the user terminal obtains the item information of the item to be purchased by scanning the graphic barcode and performing a settlement management operation based on the settlement request.

### CROSS-REFERENCES TO RELATED APPLICATIONS

This application is a continuation application of PCT Patent Application No. PCT/CN2014/084140, filed on Aug. 12, 2014, which claims priority of Chinese Patent Application No. 201310530548.2, filed on Oct. 31, 2013, the entire contents of both of which are incorporated by reference herein.

### FIELD OF THE INVENTION

The present invention generally relates to the field of computer technologies and, more particularly, to terminal-based settlement methods, apparatuses and systems.

### BACKGROUND

With the improvement of living standards, various facilities supporting people's daily lives also tend to be improved continuously, such as supermarkets and shops. People can purchase household goods without going far away, providing people with convenient living conditions.

However, currently, when there are more people purchasing items in a shop, because payment can only be settled at a checkout counter after the staff scans a barcode on the packaging of a selected item, the efficiency of the settlement process is relatively low, further reducing the intelligence of the settlement system.

Because the intelligent transaction settlement system is an important aspect of computer technology dealing with onsite transaction applications, technical solutions are needed to solve and/or improve the efficiency and intelligence of the existing transaction settlement methods and systems. The disclosed methods, apparatuses, and systems are directed to solve one or more problems set forth above and other problems.

### BRIEF SUMMARY OF THE DISCLOSURE

One aspect of the present disclosure includes a terminal-based settlement method. The method includes a settlement apparatus scanning tag information of an item to be purchased and obtaining item information of the item to be purchased, where the item information includes a unique identifier and price information of the item. The method also includes the settlement apparatus generating a graphic barcode based on the unique identifier and the price information of the item. Further, the method includes the settlement apparatus receiving a settlement request for the item sent from a user terminal after the user terminal obtains the item information of the item to be purchased by scanning the graphic barcode and performing a settlement management operation based on the settlement request.

Another aspect of the present disclosure includes a settlement apparatus. The apparatus includes a scanning and obtaining unit configured to scan tag information of an item to be purchased and obtain item information of the item, where the item information includes a unique identifier and price information of the item. The apparatus also includes a generating unit configured to, based on the unique identifier and the price information of the item, generate a graphic barcode to cause a user terminal to obtain the item information of the item based on the graphic barcode and send a settlement request for the item to the settlement apparatus. Further, the apparatus includes a settlement management unit configured to perform a settlement management operation based on the settlement request when the settlement apparatus receives the settlement request sent from the user terminal.

Another aspect of the present disclosure includes a user terminal for payment settlement by a settlement apparatus. The user terminal includes an obtaining unit configured to obtain a graphic barcode which is generated by the settlement apparatus based on item information of an item to be purchased, and to obtain the item information of the item based on the graphic barcode, where the item information includes a unique identifier and price information of the item. The user terminal also includes a request sending unit configured to, based on the item information of the item, send a settlement request to the settlement apparatus to cause the settlement apparatus to perform a settlement management operation for the item information of the item based on the settlement request. Further, the user terminal includes an interface for the user on the user terminal configured to display name information, price information, quantity, and the unique identifier of every item to be purchased, as well as provide payment methods for the user to select.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a flow chart of an exemplary terminal-based settlement process consistent with the disclosed embodiments;

FIG. 2 illustrates a flow chart of another exemplary terminal-based settlement process consistent with the disclosed embodiments;

FIG. 3 illustrates a flow chart of another exemplary terminal-based settlement process consistent with the disclosed embodiments;

FIG. 4 illustrates a schematic diagram of an exemplary settlement display interface consistent with the disclosed embodiments;

FIG. 5 illustrates a flow chart of another exemplary terminal-based settlement process consistent with the disclosed embodiments;

FIG. 6 illustrates a flow chart of another exemplary terminal-based settlement process consistent with the disclosed embodiments;

FIG. 7 illustrates a structure schematic diagram of an exemplary settlement apparatus consistent with the disclosed embodiments;

FIG. 8 illustrates a structure schematic diagram of an exemplary settlement management unit consistent with the disclosed embodiments;

FIG. 9 illustrates a structure schematic diagram of another exemplary settlement apparatus consistent with the disclosed embodiments;

FIG. 10 illustrates a structure schematic diagram of an exemplary user terminal consistent with the disclosed embodiments;

FIG. 11 illustrates a structure schematic diagram of another exemplary user terminal consistent with the disclosed embodiments; and

FIG. 12 illustrates a schematic diagram of an exemplary settlement system consistent with the disclosed embodiments.

### DETAILED DESCRIPTION

In the following description, for purposes of illustration, many specific details are illustrated in order to provide a full understanding of one or more embodiments. However, obviously, those embodiments can also be implemented in the case of these specific details changed, replaced, or alternated. The followings, together with accompanying drawings, describe in detail certain embodiments of the present invention.

A terminal-based settlement process may apply to situation where a user purchases household goods in a supermarket. For example, a settlement apparatus scans tag information of an item to be purchased and obtains item information of the item to be purchased. The settlement apparatus generates a graphic barcode based on the item information. A user terminal obtains the item information by scanning the graphic barcode and sends a settlement request to the settlement apparatus. Based on the settlement request, the settlement apparatus performs a settlement management operation. The settlement process is completed through the user terminal and the settlement apparatus.

The terminal-based settlement process may also apply to situation where a user purchases large items. For example, a settlement apparatus scans tag information of an item to be purchased and obtains item information of the item to be purchased. The settlement apparatus generates a graphic barcode based on the item information. A user terminal scans the graphic barcode and obtains the item information of the item. The settlement process is completed through the user terminal and the settlement apparatus. The settlement apparatus completes arranging shipment of the item. All of the above examples are near field shopping scenes. The settlement apparatus obtains the item information of the item to be purchased by scanning the tag information of the item to be purchased. The settlement process is completed through the user terminal and the settlement apparatus. Thus, a traditional queuing settlement method is replaced, improving the efficiency of the settlement process.

The user terminal may include Tablet personal computers (PCs), Pocket PCs, desktop computers, laptop computers, smartphones (such as Android mobile phones, iOS mobile phones, BlackBerry mobile phones, and Windows phones), Mobile Internet Devices (MID), wearable smart devices, personal digital assistants (PDAs), portable multimedia players (PMPs), and other mobile terminals. The settlement apparatus may include apparatuses capable of scanning tags, settling accounts, and managing inventory. Other servers may also be used to implement the settlement process, such as bank servers and communication servers.

The payment in the settlement process may be completed through vocal prints, fingerprints, facial recognition, two dimensional (2D) barcode technologies, etc. Specifically, the tag information may be a near field communication (NFC) or a radio frequency identification (RFID) tag or a barcode. Barcode scanning sometimes may be vulnerable to outside interference, for example, the barcode is not clear or the barcode scanner is damp. Therefore, the barcode may be replaced by a NFC or a RFID tag, such that the settlement apparatus can quickly scan the tag information, overcoming the outside interference and improving scanning speed.

The graphic barcode can be a two dimensional (2D) barcode. The 2D barcode may encapsulate a link of the item information of the item or directly encapsulate the item information of the item. The item information includes a unique identifier and price information of the item. The item may be at least one item to be purchased.

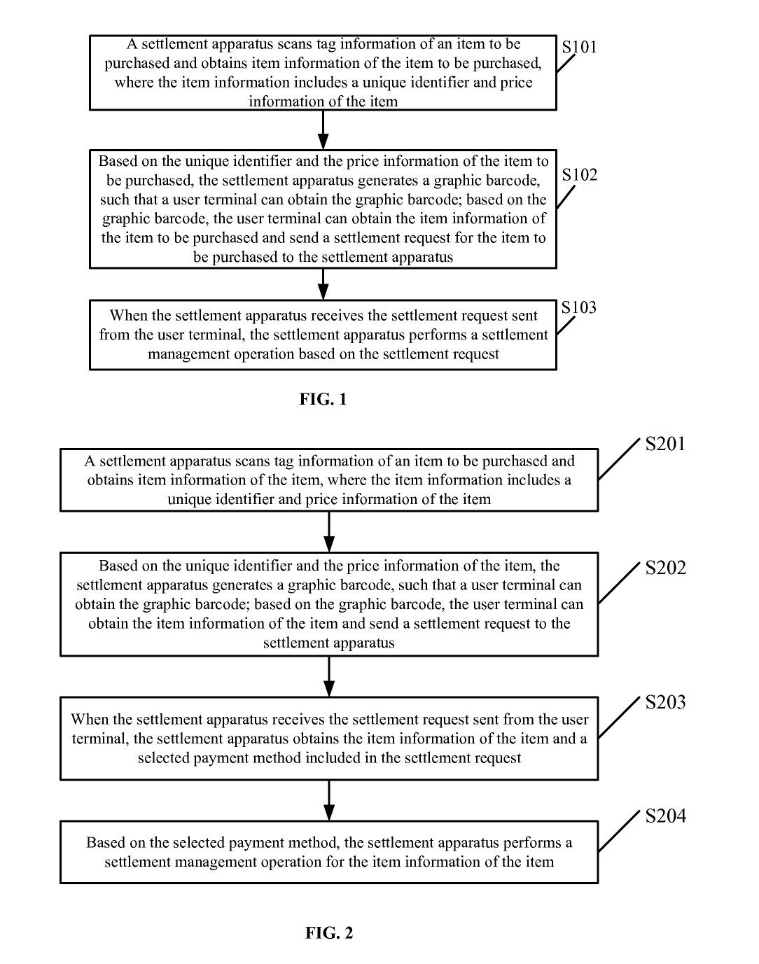

The details of the terminal-based settlement process are introduced in FIGS. 1-6. FIG. 1 illustrates a flow chart of an exemplary terminal-based settlement process consistent with the disclosed embodiments. The process is described from a settlement apparatus side. As shown in FIG. 1, the process may include the followings.

S101: a settlement apparatus scans tag information of an item to be purchased and obtains item information of the item to be purchased, where the item information includes a unique identifier and price information of the item.

Specifically, when a user finishes selecting the item in a shop and prepares to check out, the settlement apparatus may scan the tag information of the item to be purchased. In certain embodiments, the settlement apparatus may include a tag information reader/writer, such as a Near Field Communication (NFC) reader/writer and a Radio Frequency Identification (RFID) reader/writer (determined by the tag information on the packaging of the item). Near field communication (NFC) is a set of standards for smartphones and similar devices to establish radio communication with each other by touching them together or bringing them into proximity, usually no more than a few inches. Radio-frequency identification (RFID) is wireless non-contact use of radio-frequency electromagnetic fields to transfer data, for the purposes of automatically identifying and tracking tags attached to objects.

The tags contain electronically stored information. The user can place the tag information of the item to be purchased near or in front of the tag information reader/writer of the settlement apparatus, and the settlement apparatus reads from or writes to the item information of the item to be purchased. Or, instead of taking out the items to be purchased one by one, the user only needs to place a bag or a basket filled with the items to be purchased on a pre-determined position of the settlement apparatus. Then, the tag information reader/writer of the settlement apparatus reads from or writes to the item information of the items to be purchased. The settlement apparatus obtains the item information after reading from and writing to the tag information.

S102: based on the unique identifier and the price information of the item to be purchased, the settlement apparatus generates a graphic barcode, such that a user terminal can obtain the graphic barcode; based on the graphic barcode, the user terminal can obtain the item information of the item to be purchased and send a settlement request for the item to be purchased to the settlement apparatus.

Specifically, based on the obtained item information of the item to be purchased, the settlement apparatus generates the graphic barcode. The settlement apparatus outputs and displays the graphic barcode. The user may scan the graphic barcode using the user terminal. The user terminal obtains the item information of the item to be purchased and sends the settlement request for the item to be purchased to the settlement apparatus.

It should be noted that the graphic barcode can be a two dimensional (2D) barcode. A webcam and a 2D barcode scanner application of the user terminal work together to scan the 2D barcode. The 2D barcode scanner application can be an instant messaging (IM) 2D barcode scanner application on the user terminal.

S103: when the settlement apparatus receives the settlement request sent from the user terminal, the settlement apparatus performs a settlement management operation for the item based on the settlement request.

Specifically, when the settlement apparatus receives the settlement request (the settlement request includes the item information of the item to be purchased and a payment method selected by the user) sent from the user terminal, the settlement apparatus obtains the item information and the selected payment method included in the settlement request, and performs the settlement management operation for the item information of the item based on the selected payment method, where the payment method can be payment before delivery or concurrence between delivery and payment.

For example, when a merchant places a tag (a NFC or a RFID tag) or an identifier (e.g. a barcode) on each item, a user scans the tag of a selected item using a mobile phone and places the item in a shopping cart. The user may choose to pay a single item every time or pay all items as a package. The user may also choose to make a payment after the merchant packs all items and sends the package to his/her home. In addition, a payment can be settled at a checkout counter having the function for identifying the NFC or RFID tag when a shopping cart filled with the selected items pass through the checkout counter. Thus, a staff does not need to scan a barcode on the packaging of the selected item, further improving the intelligence of the settlement system.

In the present embodiment, the settlement apparatus obtains the item information of the item to be purchased by scanning the tag information of the item to be purchased. The settlement apparatus generates the graphic barcode based on the item information. The user terminal obtains the item information by scanning the graphic barcode and sends the settlement request to the settlement apparatus. Based on the settlement request, the settlement apparatus performs the settlement management operation for the item to be purchased. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, improving user experiences, further improving the intelligence of the settlement system.

FIG. 2 illustrates a flow chart of another exemplary terminal-based settlement process consistent with the disclosed embodiments. The process is described from a settlement apparatus side. As shown in FIG. 2, the process may include the followings.

S201: a settlement apparatus scans tag information of an item to be purchased and obtains item information of the item, where the item information includes a unique identifier and price information of the item.

S202: based on the unique identifier and the price information of the item, the settlement apparatus generates a graphic barcode, such that a user terminal can obtain the graphic barcode. Based on the graphic barcode, the user terminal can obtain the item information of the item and send a settlement request to the settlement apparatus.

S203: when the settlement apparatus receives the settlement request sent from the user terminal, the settlement apparatus obtains the item information of the item and a selected payment method included in the settlement request.

Specifically, the settlement apparatus obtains the settlement request sent from the user terminal, where the settlement request includes the item information of the item and the payment method selected by the user. The settlement apparatus obtains the item information of the item and the selected payment method.

S204: based on the selected payment method, the settlement apparatus performs a settlement management operation for the item information of the item.

Specifically, based on the selected payment method, the settlement apparatus performs the settlement management operation for the item information of the item, where the payment method may include payment before delivery or concurrence between delivery and payment. The settlement management operation may include the followings.

When the payment method is the payment before delivery, based on the price information of the item, the settlement apparatus debits from a user account and informs a merchant to distribute the item. When the payment method is the concurrence between delivery and payment, based on the price information of the item, the settlement apparatus debits from the user account.

It should be noted that the settlement apparatus can also update inventory information after the settlement apparatus debits from the user account. S201 and S202 in the present embodiment may refer to S101 and S102 in the embodiment shown in FIG. 1, which are not repeated here.

The settlement apparatus obtains the item information of the item to be purchased by scanning the tag information of the item to be purchased. The settlement apparatus generates the graphic barcode based on the item information. The user terminal obtains the item information by scanning the graphic barcode and sends the settlement request to the settlement apparatus. Based on the settlement request, the settlement apparatus performs the settlement management operation. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of users and improving user experiences. Further, after the settlement apparatus debits from the user account, the settlement apparatus may also update the inventory information, improving the intelligence of the settlement apparatus.

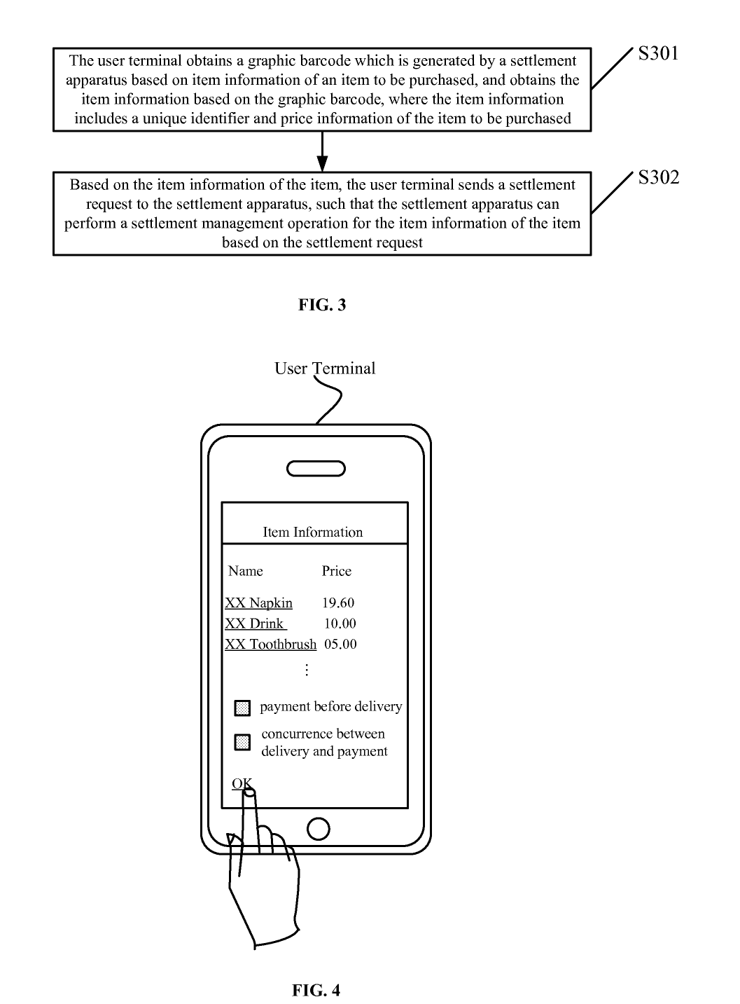

FIG. 3 illustrates a flow chart of another exemplary terminal-based settlement process consistent with the disclosed embodiments. The process is described from a user terminal side. As shown in FIG. 3, the process may include the followings.

S301: a user terminal obtains a graphic barcode which is generated by a settlement apparatus based on item information of an item to be purchased, and obtains the item information based on the graphic barcode, where the item information includes a unique identifier and price information of the item to be purchased.

Specifically, after a user finishes selecting the item in a shop and prepares to check out, based on the item information of the item to be purchased, the settlement apparatus generates the graphic barcode. The user scans the graphic barcode using the user terminal. The user terminal obtains the item information of the item.

S302: based on the item information of the item, the user terminal sends a settlement request to the settlement apparatus, such that the settlement apparatus can perform a settlement management operation for the item information of the item based on the settlement request.

Specifically, based on the item information of the item, the user terminal sends the settlement request to the settlement apparatus, where the settlement request includes the item information of the item and a payment method selected by the user.

FIG. 4 illustrates a schematic diagram of an exemplary settlement display interface consistent with the disclosed embodiments. As shown in FIG. 4, information contained in a graphic barcode may be an interface containing item information of the item, where the interface is provided by a merchant who sells the item. The graphic barcode may be provided by the settlement apparatus, by other appropriate device, or on the item to be purchased. After the user terminal scans the graphic barcode, the user terminal displays the obtained item information of the item or the items. After the user confirms the item information, the user selects the payment method on the user terminal, where the payment method may include payment before delivery or concurrence between delivery and payment, etc. After selecting the payment method, the user clicks an “OK” button. Then, the user terminal sends the settlement request to the settlement apparatus. Based on the settlement request, the settlement apparatus performs the settlement management operation for the item information of the item.

For example, after a user terminal (e.g., a smartphone equipped with a camera) scans a graphic barcode, the user terminal displays the obtained item information of an item or items on an interface. The interface on the user terminal displays name information, price information, quantity, and the unique identifier of every item to be purchased, as well as provides payment methods (e.g., payment before delivery or concurrence between delivery and payment) for a user to select. The unique identifier embodies all attributes associated with the item to be purchased. These attributes include, but are not limited to, manufacturer information, product description, material, size, color, packaging, and warranty terms.

The user terminal obtains the item information of the item by scanning the graphic barcode and sends the settlement request to the settlement apparatus. Based on the settlement request, the settlement apparatus performs the settlement management operation for the item. The settlement process is completed through the user terminal and the settlement apparatus. Thus, a traditional queuing settlement method is replaced, improving the efficiency of the settlement process, further improving the intelligence of the user terminal.

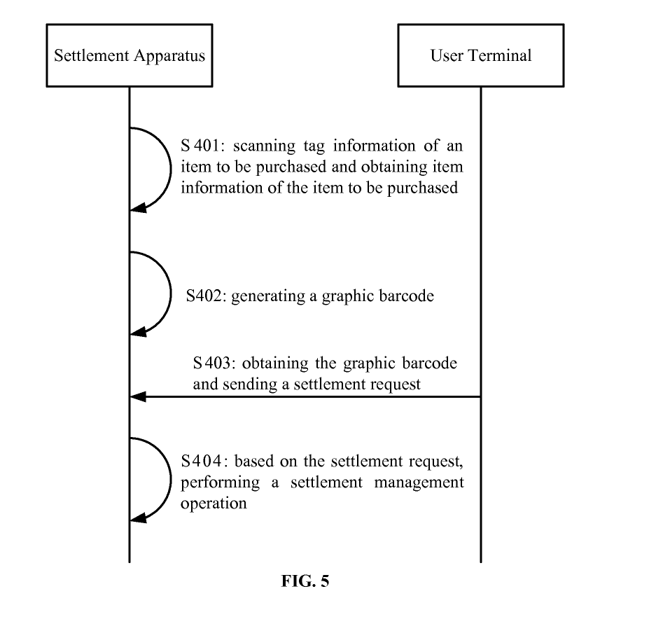

FIG. 5 illustrates a flow chart of another exemplary terminal-based settlement process consistent with the disclosed embodiments. The process is descried from both a settlement apparatus side and a user terminal side. As shown in FIG. 5, the process may include the followings.

S401: the settlement apparatus scans tag information of an item to be purchased and obtains item information of the item to be purchased, where the item information includes a unique identifier and price information of the item.

Specifically, after a user finishes selecting the item in a shop and prepares to check out, the settlement apparatus scans tag information of the item to be purchased. In certain embodiments, the settlement apparatus may include a tag information reader/writer, such as a Near Field Communication (NFC) reader/writer and a Radio Frequency Identification (RFID) reader/writer (determined by the tag information on the packaging of the item). The user can place the tag information reader/writer near or in front of the tag information of the item to be purchased, and the settlement apparatus reads from or writes to the item information of the item. Or, instead of taking out the items to be purchased one by one, the user only needs to place a bag or a basket filled with the items to be purchased on a pre-determined position of the settlement apparatus. Then, the tag information reader/writer of the settlement apparatus reads from or writes to the item information of the items to be purchased. The settlement apparatus obtains the item information after reading from and writing to the tag information.

S402: based on the unique identifier of each item and the price information, the settlement apparatus generates a graphic barcode for the item or the items.

Specifically, based on the obtained item information of the item or the items, the settlement apparatus generates the graphic barcode. The settlement apparatus can output and display the graphic barcode.

S403: the user terminal obtains the graphic barcode, obtains the item information of the item or the items based on the graphic barcode, and sends a settlement request to the settlement apparatus.

Specifically, the user may scan the graphic barcode using the user terminal. The user terminal obtains the item information of the item and sends the settlement request to the settlement apparatus.

It should be noted that the graphic barcode can be a 2D barcode. A webcam and a 2D barcode scanner application of the user terminal work together to scan the 2D barcode. The 2D barcode scanner application can be an IM 2D barcode scanner application on the user terminal.

S404: based on the settlement request, the settlement apparatus performs a settlement management operation for the item.

Specifically, when the settlement apparatus receives the settlement request sent from the user terminal (the settlement request includes the item information of the item and a payment method selected by the user), the settlement apparatus obtains the item information of the item and the selected payment method included in the settlement request, and performs the settlement management operation for the item information of the item based on the selected payment method, where the payment method may include payment before delivery or concurrence between delivery and payment.

The settlement apparatus obtains the item information of the item by scanning the tag information of the item to be purchased. The settlement apparatus generates the graphic barcode based on the item information. The user terminal obtains the item information by scanning the graphic barcode and sends the settlement request to the settlement apparatus. Based on the settlement request, the settlement apparatus performs the settlement management operation. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of users and improving user experiences. Further, after the settlement apparatus debits from the user account, the settlement apparatus may also update inventory information, improving the intelligence of the settlement apparatus.

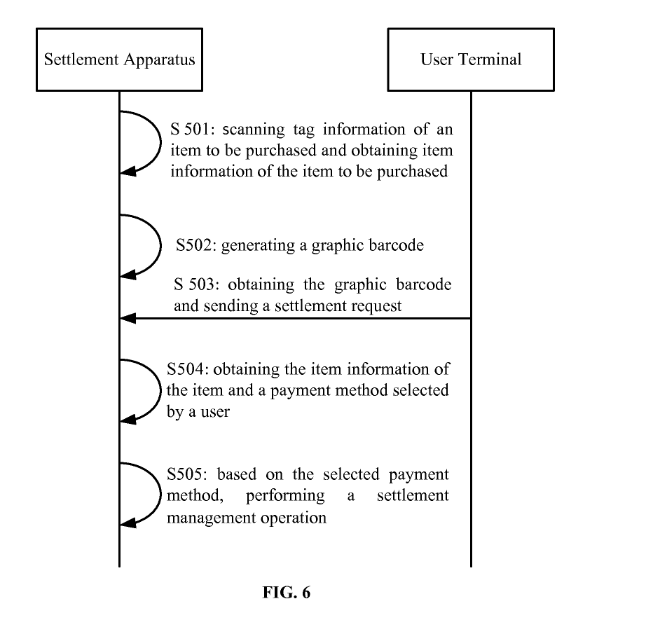

FIG. 6 illustrates a flow chart of another exemplary terminal-based settlement process consistent with the disclosed embodiments. The process is descried from both a settlement apparatus side and a user terminal side. As shown in FIG. 6, the process may include the following steps.

S501: a settlement apparatus scans tag information of an item to be purchased, and obtains item information of the item to be purchased, where the item information includes a unique identifier and price information of the item.

S502: based on the unique identifier and the price information of the item, the settlement apparatus generates a graphic barcode.

S503: the user terminal obtains the graphic barcode, obtains the item information of the item based on the graphic barcode, and sends a settlement request to the settlement apparatus.

S504: the settlement apparatus obtains the item information of the item and a payment method selected by a user included in the settlement request.

Specifically, the settlement apparatus obtains the settlement request sent from the user terminal, where the settlement request includes the item information of the item and the payment method selected by the user. The settlement apparatus obtains the item information of the item and the selected payment method.

S505: based on the selected payment method, the settlement apparatus performs a settlement management operation for the item information of the item.

Specifically, based on the payment method selected by the user, the settlement apparatus performs the settlement management operation for the item information of the item, where the payment method may include payment before delivery or concurrence between delivery and payment. The settlement management operation may include the followings.

When the payment method is the payment before delivery, based on the price information of the item, the settlement apparatus debits from a user account and informs a merchant to distribute the item. When the payment method is the concurrence between delivery and payment, based on the price information of the item, the settlement apparatus debits from the user account.

It should be noted that the settlement apparatus can also update inventory information after the settlement apparatus debits from the user account. S501, S502 and S503 in the present embodiment may refer to S401, S402 and S403 shown in FIG. 5, which are not repeated here.

The settlement apparatus obtains the item information of the item to be purchased by scanning the tag information of the item to be purchased. The settlement apparatus generates the graphic barcode based on the item information. The user terminal obtains the item information by scanning the graphic barcode and sends the settlement request to the settlement apparatus. Based on the settlement request, the settlement apparatus performs the settlement management operation. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of the users and improving user experiences. Further, after the settlement apparatus debits from the user account, the settlement apparatus may also update the inventory information, improving the intelligence of the settlement apparatus.

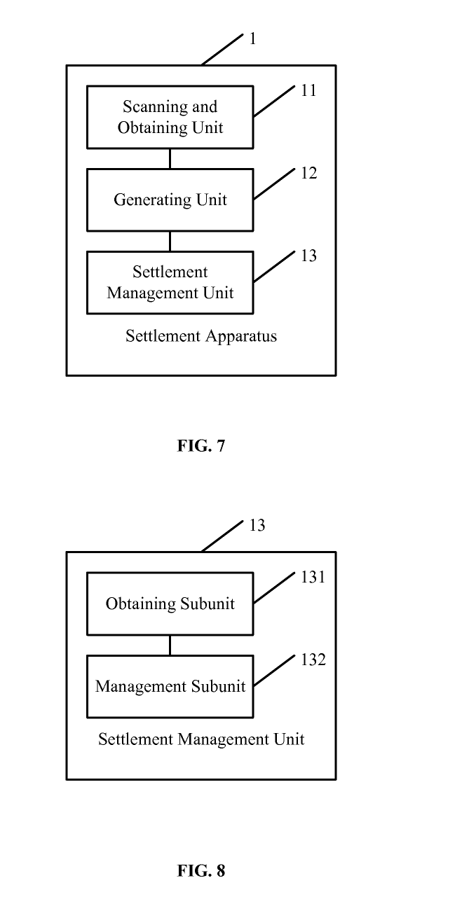

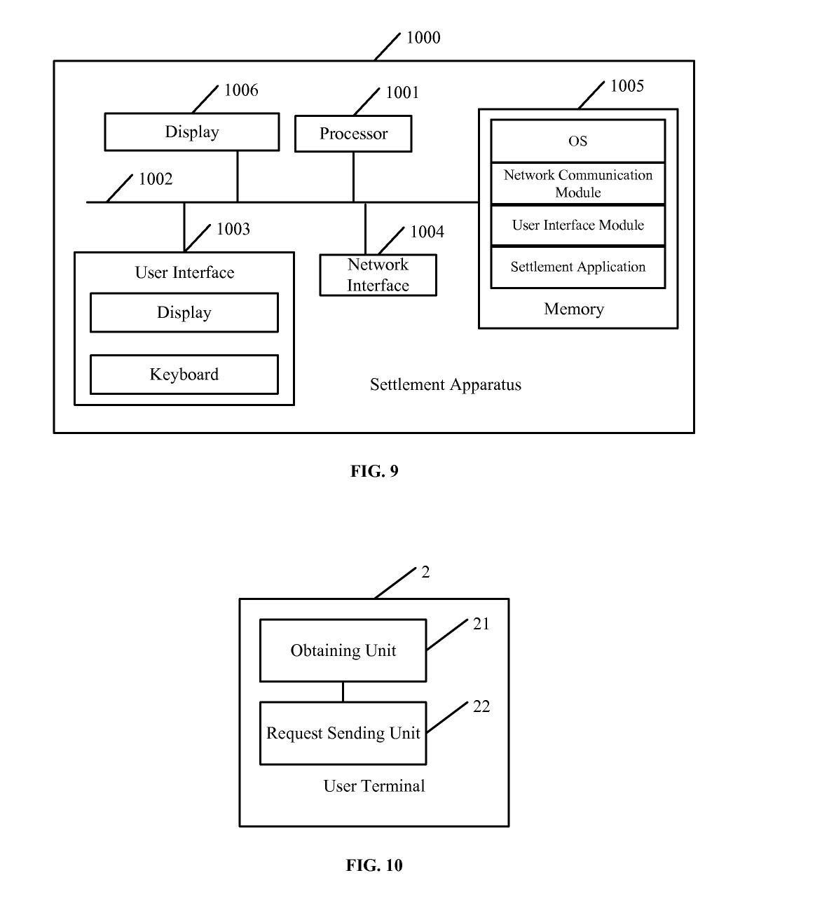

The settlement apparatus provided in this disclosure is described in details in accordance with FIG. 7, FIG. 8 and FIG. 9. It should be noted that the settlement apparatus described in FIG. 7, FIG. 8 and FIG. 9 is configured to implement the process shown in FIG. 1 and FIG. 2. For illustration purposes, only part related with the disclosed embodiments is shown herein. The specific technical details are not repeated, which refer to the embodiments in FIG. 1 and FIG. 2.

FIG. 7 illustrates a structure schematic diagram of an exemplary settlement apparatus consistent with the disclosed embodiments. As shown in FIG. 7, the settlement apparatus may include a scanning and obtaining unit 11, a generating unit 12, and a settlement management unit 13.

The scanning and obtaining unit 11 is configured to scan tag information of an item to be purchased and obtain item information of the item, where the item information includes a unique identifier and price information of the item.

Specifically, when a user finishes selecting the item and prepares to check out, the scanning and obtaining unit 11 scans the item to be purchased. In certain embodiments, the scanning and obtaining unit 11 may include a tag information reader/writer, such as a Near Field Communication (NFC) reader/writer and a Radio Frequency Identification (RFID) reader/writer (determined by the tag information on the packaging of the item). The user can place the tag information reader/writer of the scanning and obtaining unit 11 near or in front of the tag information of the item to be purchased, the tag information reader/writer reads from or writes to the item information of the item to be purchased. Or, instead of taking out the items one by one, the user only needs to place a bag or a basket filled with the items to be purchased on a pre-determined position of the settlement apparatus 1. Then, the tag information reader/writer of the scanning and obtaining unit 11 reads from or writes to the item information of the items to be purchased. The scanning and obtaining unit 11 obtains the item information after reading and writing.

The generating unit 12 is configured to, based on the unique identifier and the price information of the item, generate a graphic barcode. A user terminal can obtain the graphic barcode, obtain the item information of the item based on the graphic barcode, and send a settlement request to the settlement apparatus.

Specifically, based on the item information obtained by the scanning and obtaining unit 11, the generating unit 12 generates the graphic barcode. The settlement apparatus 1 can output and display the graphic barcode. The user can scan the graphic barcode using the user terminal. The user terminal obtains the item information of the item and sends the settlement request to the settlement apparatus 1.

It should be noted that the graphic barcode can be a 2D barcode. A webcam and a 2D barcode scanner application of the user terminal work together to scan the 2D barcode. The 2D barcode scanner application can be an IM 2D barcode scanner application on the user terminal.

The settlement management unit 13 is configured to, when the settlement apparatus receives the settlement request sent from the user terminal, perform a settlement management operation based on the settlement request.

Specifically, when the settlement apparatus 1 receives the settlement request sent from the user terminal (the settlement request includes the item information of the item and a payment method selected by the user), the settlement management unit 13 obtains the item information of the item and the selected payment method included in the settlement request, and performs the settlement management operation for the item information of the item based on the selected payment method (the payment method can be payment before delivery and concurrence between delivery and payment).

FIG. 8 illustrates a structure schematic diagram of an exemplary settlement management unit consistent with the disclosed embodiments. As shown in FIG. 8, the settlement management unit may include an obtaining subunit 131 and a management subunit 132.

The obtaining subunit 131 is configured to, when the settlement apparatus receives a settlement request sent from a user terminal, obtain item information of an item and a selected payment method included in the settlement request.

Specifically, the settlement apparatus obtains the settlement request sent from the user terminal (the settlement request includes the item information of the item and the selected payment method). The obtaining subunit 131 obtains the item information of the item and the selected payment method.

The management subunit 132 is configured to, based on the selected payment method, perform a settlement management operation.

Specifically, based on the selected payment method, the management subunit 132 performs the settlement management operation. The payment method can be payment before delivery and concurrence between delivery and payment. The settlement management operation may include the followings.

When the payment method is the payment before delivery, based on the price information of the item, the management subunit 132 debits from a user account and informs a merchant to distribute the item.

When the payment method is the concurrence between delivery and payment, based on the price information of the item, the management subunit 132 debits from the user account.

It should be noted that the management subunit 132 can also update inventory information after the management subunit 132 debits from the user account.

In the present embodiment, the settlement apparatus obtains the item information of the item to be purchased by scanning the tag information of the item to be purchased. The settlement apparatus generates the graphic barcode based on the item information. The user terminal obtains the item information of the item by scanning the graphic barcode, and sends the settlement request to the settlement apparatus. The settlement apparatus performs the settlement management operation based on the settlement request. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of users and improving user experiences. Further, after the settlement apparatus debits from the user account, the settlement apparatus may also update the inventory information, improving the intelligence of the settlement apparatus.

FIG. 9 illustrates a structure schematic diagram of another exemplary settlement apparatus consistent with the disclosed embodiments. As shown in FIG. 9, the settlement apparatus 1000 may include a processor 1001, at least one network interface 1004, a user interface 1003, a memory 1005, at least one communication bus 1002, and a display screen 1006.

The network interface 1004, the memory 1005, the processor 1001, and the user interface 1003 communicate with each other via one or more communication buses 1002. The user interface 1003 may include a display screen (e.g., a liquid crystal display (LCD) or a cathode ray tube (CRT)), a keyboard, and other wired communication and/or wireless interface(s). The user interface 1003 is configured to provide input interface for the user, and obtain data outputted by the user.

The network interface 1004 may be an interface of a communication module, such as an interface of a network card. The network interface 1004 is configured to connect the settlement apparatus 1000 and communicate data with the user terminal. The network interface 1004 may include wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends Radio Frequency (RF) signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol.

The memory 1005 is configured to store software programs, modules, instructions, and data structures. The one or more processors 1001 are coupled to the memory 1005 and operable to execute these programs, modules, and instructions, and read from or write to the data structures stored in the memory 1005 for implementing various functions of the settlement apparatus. The memory 1005 includes a memory program area and a memory data area. The memory program area stores operating systems, network communication modules, user interface modules, applications (such as settlement applications, etc.), and so on. For example, an operating system includes various software components and/or drivers for controlling and managing general system tasks (e.g., memory management, storage device control, power management, etc.) and facilitates communications between various hardware, firmware, and software components.

The memory 1005 may include high-speed random access memory (RAM), such as DRAM, SRAM, or other random access solid state memory devices. The memory 1005 may also include non-volatile memory, such as one or more magnetic disk storage devices, optical disk storage devices, flash memory devices, or other non-volatile solid state storage devices.

The processor 1001 may include any appropriate processor or processors. Further, the processor 1001 can include multiple cores for multi-thread or parallel processing. The processor may be General Processor, central processing unit (CPU), Microprogrammed Control Unit (MCU), digital signal processor (DSP), graphics processing unit (GPU), system on a chip (SOC), application specific integrated circuits (ASIC), etc. The processor 1001 is configured to execute the following operations by calling a settlement application stored in the memory 1005.

The settlement apparatus 1000 obtains item information of an item to be purchased by scanning tag information of the item to be purchased, where the item information includes a unique identifier and price information of the item.

Based on the unique identifier and the price information, the settlement apparatus 1000 generates a graphic barcode, such that a user terminal can obtain the graphic barcode and obtain the item information of the item based on the graphic barcode. Then, the user terminal sends a settlement request to the settlement apparatus 1000. The graphic barcode can be outputted through the display screen 1006.

When the settlement apparatus 1000 receives the settlement request sent from the user terminal, based on the settlement request, the settlement apparatus 1000 performs a settlement management operation for the item.

In certain embodiments, the settlement request includes the item information of the item and a payment method selected by the user.

In certain embodiments, based on the settlement request, the processor 1001 performs the settlement management operation further includes the followings.

The settlement apparatus obtains the item information of the item and the selected payment method. Based on the selected payment method, the settlement apparatus performs the settlement management operation for the item information of the item. In certain embodiments, the payment method may include payment before delivery or concurrence between delivery and payment.

When the payment method is the payment before delivery, based on the selected payment method, the processor 1001 performs the settlement management operation for the item information of the item, debits from a user account based on the price information of the item, and informs a merchant to distribute the item.

When the payment method is the concurrence between delivery and payment, based on the selected payment method, the processor 1001 performs the settlement management operation for the item information of the item and debits from the user account based on the price information of the item.

In the present embodiment, the settlement apparatus obtains the item information of the item by scanning the tag information of the item to be purchased. The settlement apparatus generates the graphic barcode based on the item information. The user terminal obtains the item information of the item by scanning the graphic barcode, and sends the settlement request to the settlement apparatus. Based on the settlement request, the settlement apparatus performs the settlement management operation. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of users and improving user experiences. Further, after the settlement apparatus debits from the user account, the settlement apparatus may also update the inventory information, improving the intelligence of the settlement apparatus.

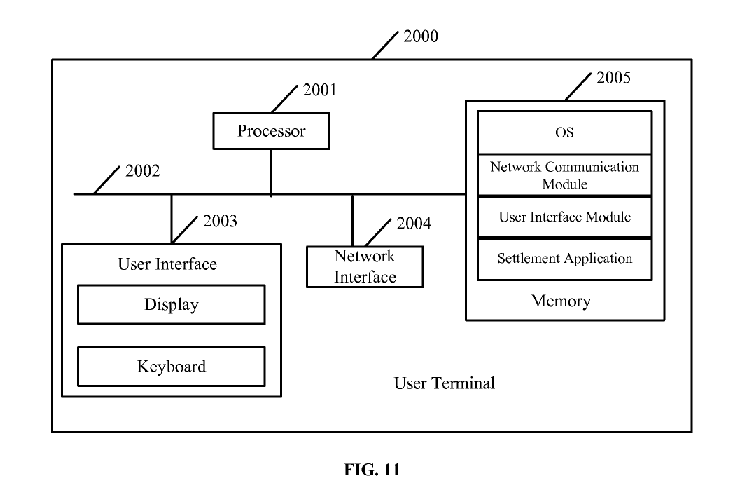

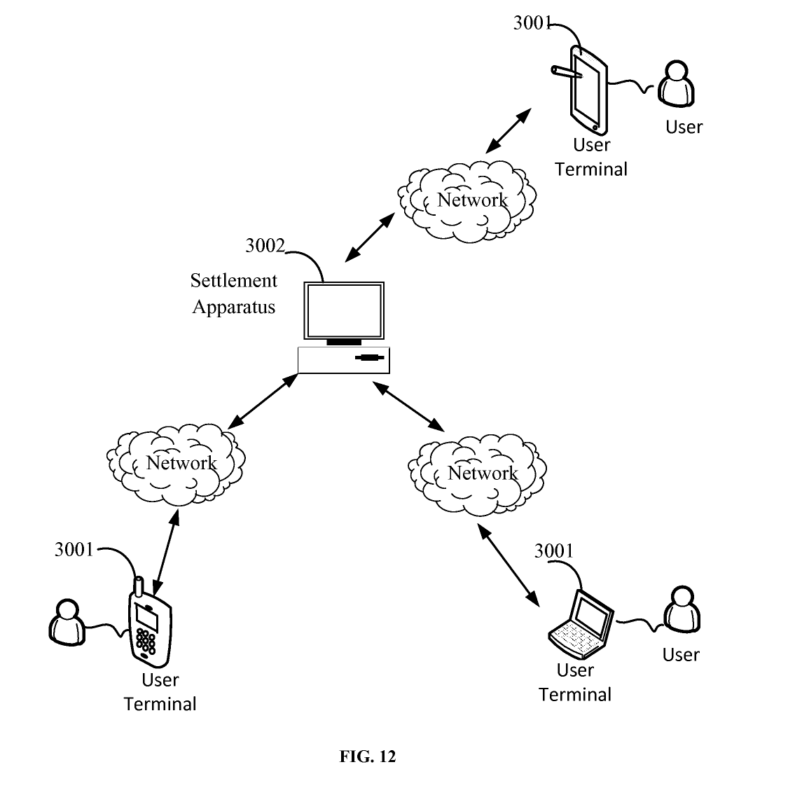

The user terminal provided in the present disclosure is described in accordance with FIG. 10 and FIG. 11. It should be noted that the user terminal shown in FIG. 10 and FIG. 11 is used to implement the process shown in FIG. 3 and FIG. 4. For illustration purposes, only part related with the disclosed embodiments is shown herein. The specific technical details are not repeated, which refers to the embodiments in FIG. 3 and FIG. 4.

FIG. 10 illustrates a structure schematic diagram of an exemplary user terminal consistent with the disclosed embodiments. As shown in FIG. 10, the user terminal 2 may include an obtaining unit 21 and a request sending unit 22.

The obtaining unit 21 is configured to obtain a graphic barcode generated by a settlement apparatus based on item information of an item to be purchased, and obtain the item information of the item based on the graphic barcode, where the item information includes a unique identifier and price information of the item.

Specifically, when a user finishes selecting the item and prepares to check out, based on the item information of the item to be purchased, the settlement apparatus generates the graphic barcode. The user scans the graphic barcode using the user terminal 2. The obtaining unit 21 obtains the item information of the item.

The request sending unit 22 is configured to, based on the item information of the item, send a settlement request to the settlement apparatus, such that the settlement apparatus performs a settlement management operation for the item information of the item based on the settlement request.

Specifically, based on the item information of the item, the request sending unit 22 may send the settlement request to the settlement apparatus, where the settlement request may include the item information of the item and the selected payment method.

In the present embodiment, the user terminal obtains the item information of the item by scanning the graphic barcode and sends the settlement request to the settlement apparatus. Based on the settlement request, the settlement apparatus performs the settlement management operation for the item. The settlement process is completed through the user terminal and the settlement apparatus. Thus, a traditional queuing settlement method is replaced, improving the efficiency of the settlement process.

FIG. 11 illustrates a structure schematic diagram of another exemplary user terminal consistent with the disclosed embodiments. As shown in FIG. 11, the user terminal 2000 may include at least one processor 2001, at least one network interface 2004, a user interface 2003, a memory 2005, and at least one communication bus 2002.

The network interface 2004, the memory 2005, the processor 2001, and the user interface 2003 communicate with each other via one or more communication buses 2002.

The user interface 2003 may include a display screen (e.g., a liquid crystal display (LCD) or a cathode ray tube (CRT)), a keyboard, and other wired communication and/or wireless interface(s). The user interface 2003 is configured to provide input interface for the user and obtain data outputted by the user.

The network interface 2004 may be an interface of a communication module, such as an interface of a network card. The network interface 2004 is configured to connect a management apparatus of a merchant who sells the item and communicate data with the user terminal 2000. The network interface 2004 may include wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends Radio Frequency (RF) signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol.

The memory 2005 is configured to store software programs, modules, instructions, and data structures. The one or more processors 2001 are coupled to the memory 2005 and operable to execute these programs, modules, and instructions, and read from or write to the data structures stored in the memory 2005 for implementing various functions of the payment server. The memory 2005 includes a memory program area and a memory data area. The memory program area stores operating systems, network communication modules, user interface modules, applications (such as settlement applications, etc.), and so on. For example, an operating system includes various software components and/or drivers for controlling and managing general system tasks (e.g., memory management, storage device control, power management, etc.) and facilitates communications between various hardware, firmware, and software components.

The memory 2005 may include high-speed random access memory (RAM), such as DRAM, SRAM, or other random access solid state memory devices. The memory 2005 may also include non-volatile memory, such as one or more magnetic disk storage devices, optical disk storage devices, flash memory devices, or other non-volatile solid state storage devices.

The processor 2001 may include any appropriate processor or processors. Further, the processor 2001 can include multiple cores for multi-thread or parallel processing. The processor may be General Processor, central processing unit (CPU), Microprogrammed Control Unit (MCU), digital signal processor (DSP), graphics processing unit (GPU), system on a chip (SOC), application specific integrated circuits (ASIC), etc. The processor 2001 is configured to execute the following operations by calling a settlement application stored in the memory 2005.

Based on item information of an item to be purchased, a graphic barcode generated by the settlement apparatus 2000 is obtained; and based on the graphic barcode, the item information of the item is obtained, where the item information includes a unique identifier and price information of the item.

Based on the item information of the item, a settlement request is sent to the settlement apparatus, such that the settlement apparatus 2000 performs a settlement management operation based on the item information of the item.

In the present embodiment, the user terminal obtains the item information of the item by scanning the graphic barcode and sends the settlement request to the settlement apparatus. Based on the settlement request, the settlement apparatus performs the settlement management operation for the item. The settlement process is completed through the user terminal and the settlement apparatus. Thus, a traditional queuing settlement method is replaced, improving the efficiency of the settlement process.

FIG. 12 illustrates a schematic diagram of an exemplary settlement system consistent with the disclosed embodiments. As shown in FIG. 12, the settlement system may include a user terminal 3001 and a settlement apparatus 3002.

The user terminal 3001 may connect to the settlement apparatus 3002 via a network, where the settlement apparatus 3002 may be one of the above settlement apparatuses described in FIG. 7, FIG. 8, and FIG. 9, and the user terminal 3001 may be one of the above user terminals described in FIG. 10 and FIG. 11.

The settlement apparatus 3002 is configured to obtain item information of an item by scanning tag information of the item to be purchased, where the item information includes a unique identifier and price information of the item.

The settlement apparatus 3002 is also configured to, based on the unique identifier and the price information of the item, generate a graphic barcode.

The user terminal 3001 is also configured to obtain the graphic barcode, obtain the item information of the item based on the graphic barcode, and send a settlement request to the settlement apparatus 3002.

The settlement request includes the item information of the item and a payment method selected by a user.

The settlement apparatus 3002 is also configured to, based on the settlement request, perform a settlement management operation, where the settlement management operation includes obtaining the item information of the item and the selected payment method included in the settlement request and performing the settlement management operation for the item information of the item based on the selected payment method.

Specifically, the payment method can be payment before delivery and concurrence between delivery and payment. When the payment method is the payment before delivery, based on the selected payment method, the settlement apparatus 3002 performs the settlement management operation for the item information of the item, where the settlement management operation includes debiting from a user account based on the price information of the item and informing a merchant to distribute the item.

When the payment method is the concurrence between delivery and payment, based on the selected payment method, the settlement apparatus 3002 performs the settlement management operation for the item information of the item, where the settlement management operation includes debiting from the user account based on the price information of the item.

In the present embodiment, the settlement apparatus obtains the item information of the item by scanning the tag information of the item to be purchased. The settlement apparatus generates the graphic barcode based on the item information. The user terminal obtains the item information of the item by scanning the graphic barcode, and sends the settlement request to the settlement apparatus. Based on the settlement request, the settlement apparatus performs the settlement management operation for the item. The settlement process is completed through the user terminal and the settlement apparatus. Thus, a traditional queuing settlement method is replaced, improving the efficiency of the settlement process. In addition, the settlement apparatus may perform the settlement management operation based on the payment method selected by the user, such as payment before delivery or concurrence between delivery and payment, meeting different needs of users and improving user experiences, thus improving the intelligence of the settlement apparatus.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those skilled in the art may implement the described functionality in varying ways for each particular application, but such implementation decisions should not be interpreted as being a departure from the scope of the present invention.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed settlement methods, apparatuses and systems using a user terminal, the settlement apparatus obtains the item information of the selected item by scanning the tag information of the item to be purchased. The settlement apparatus generates the graphic barcode based on the item information. The user terminal obtains the item information by scanning the graphic barcode and sends the settlement request to the settlement apparatus. Based on the settlement request, the settlement apparatus performs the settlement management operation for the item to be purchased. The settlement process is completed through the user terminal and the settlement apparatus. A traditional queuing settlement method is replaced, improving the efficiency of the settlement process. In addition, the settlement apparatus may perform the settlement management operation based on the payment method selected by the user, such as payment before delivery or concurrence between delivery and payment, improving user experiences, further improving the intelligence of the settlement system.

What is claimed is:

1. A terminal-based settlement method, comprising:
scanning, by a settlement apparatus, tag information of an item to be purchased;
obtaining, by the settlement apparatus, item information of the item to be purchased, wherein the item information includes a unique identifier and price information of the item;
based on the unique identifier and the price information of the item, generating, by the settlement apparatus, a graphic barcode;
receiving, by the settlement apparatus, a settlement request for the item sent from a user terminal after the user terminal obtains the item information of the item to be purchased by scanning the graphic barcode; and
based on the settlement request, performing, by the settlement apparatus, a settlement management operation.

2. The method according to claim 1, wherein:
the settlement request includes the item information of the item and a payment method selected by a user.

3. The method according to claim 1, wherein performing a settlement management operation based on the settlement request further includes:
obtaining, by the settlement apparatus, the item information of the item and the selected payment method included in the settlement request; and
based on the selected payment method, performing, by the settlement apparatus, the settlement management operation for the item information of the item.

4. The method according to claim 3, wherein:
the payment method is one of payment before delivery and concurrence between delivery and payment.

5. The method according to claim 4, wherein:
when the payment method is the payment before delivery, based on the selected payment method, the settlement apparatus performs the settlement management operation for the item information of the item, wherein the settlement management operation includes debiting from a user account based on the price information of the item and informing a merchant to distribute the item; and
when the payment method is the concurrence between delivery and payment, based on the selected payment method, the settlement apparatus performs the settlement management operation for the item information of the item, wherein the settlement management operation includes debiting from the user account based on the price information of the item.

6. The method according to claim 1, wherein:
the tag information is any one of a near field communication (NFC) tag and a radio frequency identification (RFID) tag.

7. The method according to claim 1 wherein:
the graphic barcode is a two dimensional (2D) barcode.

8. A settlement apparatus, comprising:
a scanning and obtaining unit configured to scan tag information of an item to be purchased and obtain item information of the item, wherein the item information includes a unique identifier and price information of the item;
a generating unit configured to, based on the unique identifier and the price information of the item, generate a graphic barcode to cause a user terminal to obtain the item information of the item based on the graphic barcode and send a settlement request for the item to the settlement apparatus; and
a settlement management unit configured to, when the settlement apparatus receives the settlement request sent from the user terminal, perform a settlement management operation based on the settlement request.

9. The apparatus according to claim 8, wherein:
the settlement request includes the item information of the item and a payment method selected by a user.

10. The apparatus according to claim 9, wherein the settlement management unit further includes:
an obtaining subunit configured to, when the settlement apparatus receives the settlement request sent from the user terminal, obtain the item information of the item and the selected payment method included in the settlement request; and
a management subunit configured to, based on the selected payment method, perform the settlement management operation for the item information of the item.

11. The apparatus according to claim 10, wherein:
the payment method is one of payment before delivery and concurrence between delivery and payment.

12. The apparatus according to claim 11, wherein:
when the payment method is the payment before delivery, based on the price information of the item, the management subunit is configured to debit from a user account and inform a merchant to distribute the item; and
when the payment method is the concurrence between delivery and payment, based on the price information of the item, the management subunit is configured to debit from the user account.

13. The apparatus according to claim 8, wherein:
the tag information is any one of a near field communication (NFC) tag and a radio frequency identification (RFID) tag.

14. The apparatus according to claim 8, wherein:
the graphic barcode is a two dimensional (2D) barcode.

15. A user terminal for payment settlement by a settlement apparatus, comprising:
an obtaining unit configured to obtain a graphic barcode which is generated by the settlement apparatus based on item information of an item to be purchased, and to obtain the item information of the item based on the graphic barcode, wherein the item information includes a unique identifier and price information of the item; and
a request sending unit configured to, based on the item information of the item, send a settlement request to the settlement apparatus to cause the settlement apparatus to perform a settlement management operation for the item information of the item based on the settlement request.

16. The user terminal according to claim 15, wherein:
an interface for a user on the user terminal displays name information, price information, quantity, and the unique identifier of every item to be purchased, as well as provides payment methods for the user to select.

17. The user terminal according to claim 15, wherein:
the settlement request includes the item information of the item and a payment method selected by a user.

18. The user terminal according to claim 15, wherein:
the graphic barcode is a two dimensional (2D) barcode.

19. The user terminal according to claim 16, wherein:
the payment method is one of payment before delivery and concurrence between delivery and payment.

20. The user terminal according to claim 16, wherein:
the unique identifier embodies all attributes associated with the item to be purchased, wherein the attributes include manufacturer information, product description, material, size, color, packaging, and warranty terms.
